(19) United States
(12) Patent Application Publication
(10) Pub. No.: US 2004/0046146 A1
(43) Pub. Date: Mar. 11, 2004

(54) Complex esters for use with fluorinated refrigerants

(75) Inventors: Kjell Ankner, Molnlycke (SE); Essi Glad, Porvoo (FI); Mikko Aalto, Vantaa (FI); Virpi Saranpaa, Helsinki (FI)

Correspondence Address: BIRCH STEWART KOLASCH & BIRCH, PO BOX 747, FALLS CHURCH, VA, 22040-0747, US

(73) Assignee: Neste Chemicals OY

(21) Appl. No.: 10/676,530

(22) Filed: Sep. 30, 2003

Related U.S. Application Data
(63) Continuation of application No. 09/978,987, filed on Oct. 15, 2001, now abandoned.
Application No. 09/978,987 is a continuation of application No. 09/402,669, filed on Oct. 8, 1999, now abandoned.
Application No. 09/402,669 is a 371 of international application No. PCT/FI98/00312, filed on Apr. 8, 1998.

(30) Foreign Application Priority Data
Apr. 11, 1997 (FI) 971548

(51) Int. Cl. C09K 5/00; F25D 1/00

(52) U.S. Cl. 252/68

(57) ABSTRACT

The invention concerns refrigerant compositions which comprise a hydrofluorocarbon based refrigerant and, mixed with the refrigerant, a polyol ester based lubricant. According to the invention the polyol ester comprises a diol having a strongly sterically hindered hydrogen attached to the carbon in position 2, said diol being esterified with a mixture of mono- and diabasic carboxylic acids. In particular the diol is 2-ethyl-1,3-hexanediol or 1,4-dimethylol-cyclohexane. The complex esters in refrigerant mixtures have good lubricant properties and good solubility in HFC compounds.

This application is a continuation of co-pending U.S. patent application Ser. No. 09/987,987 filed on Oct. 15, 2001, which is a continuation of 09/402,669 filed Oct. 8, 1999, now abandoned, the entire contents both of which are hereby incorporated by reference. This application also reclaims priority to International Application No. PCT/FI98/00312 filed on Apr. 8, 1998 under the Patent Cooperation Treaty and Finnish Patent Application 971548 filed in Finland on Apr. 11, 1997 under 35. U.S.C. §120/119.

The present invention concerns a refrigerant composition according to the preamble of claim 1. A composition of the present kind generally contains a non-chlorinated hydrofluorocarbon based refrigerant composition together with a polyolester-based lubricant mixed therewith.

Lately, as a result of development in many fields of application, the evolution of polyolester type lubricants has been rapid. These products can be used as such or mixed with another base oil, such as a hydrocarbon, in engine oils for automotives, in aeroplane and gas turbine oils, as biodegradable hydraulic oils, as metal working oils and as compressor oils. These products are used in particular together with fluorinated refrigerants as a soluble lubricant component in refrigeration compressors due to their advantageous solubility properties, good technical stability and good cold properties.

The use of neopentylglycol and pentaerytritol esters together with refrigerants has been generally suggested. Although these known esters in principle exhibit good lubricant properties, their solubility in non-chlorinated hydrofluorocarbons is often only fair. For this reason they do not work well enough in refrigerant compositions containing fluorinated hydrocarbons.

It is an object of the present invention to eliminate the problems of the prior art and to provide improved polyol-based esters of a novel kind which can be used in particular together with fluorinated refrigerants as lubricants.

It is generally believed that stable polyolester should have a neopentyl structure, i.e. that the polyol residue should contain no β hydrogen. The present invention is based on the finding that polyols containing a sterically hindered β hydrogen are chemically and technically stable and complex esters of these diols work very well as lubricants in refrigerant compositions containing fluorinated refrigerants. Said esters have good lubricant properties and their solubility in fluorinated refrigerants is also good or excellent. In particular, the lubricants comprise complex ester which have been prepared from a mixture of 2-ethyl-1,3-hexanediol or 1,4-dimethylol-cyclohexane together with a mono- or bivalent carboxylic acid. More specifically, the present invention is generally characterized by what is stated in the characterizing part of claim 1.

The present invention provides considerable advantages. In addition to having good lubricant properties and good solubility in HFC compounds used as refrigerants, the complex esters are also economically advantageous. Thus, 2-ethyl-1,3-hexanediol can be produced by the oxo-process (hydroformulation). Furthermore, the properties of the oil can easily be modified depending on the application by varying the polyol of the ester or, if several polyols are used, by adjusting the ratio of the polyols, the esterifying carboxylic acid and/or the ratio between the esterifying carboxylic acids. By using branched acids the solubility can be improved and by using dibasic acids the viscosity can be raised.

In the following, the invention will be examined with the aid of a detailed description and using a number of working examples.

The present esters comprise esters of a chemically and technically stable diol, at least a part of the esterifying carboxylic acids of said esters being dibasic. Both carboxylic groups of these acids react with alcohols and yield oligomeric ester compounds. Complex esters include esters having a carboxylic acid residue formed by a hydroxy acid containing both a hydroxyl group and a carboxylic group. The carboxylic group reacts with the polyol, whereas the hydroxyl group reacts with the carboxylic group of another carboxylic acid.

“Polyol” stands for a compound with at least two hydroxyl groups. According to the present invention, ETHD or CHDM can be esterified when they are mixed with each other or with another polyol. These polyols are, e.g., NPG (neopentyl glycol), HPHP (hydroxy-pivalyl hydroxypivalate), TMP (trimethylol propane), TME (trimethylol ethane), PE (pentaerythritol), TMPD (2,2,4-trimethyl pentanediol) and 2-butyl-2-ethyl-1,3-propanediol.

Preferably the polyol ester mixtures are formed by mixing the polyols together and by esterifying the thus formed mixture in situ.

In the “chemically and technically stable” polyols according to the present invention, the carbon atom in position 2 contains a strongly hindered hydrogen. The formulas of the preferred compounds are:

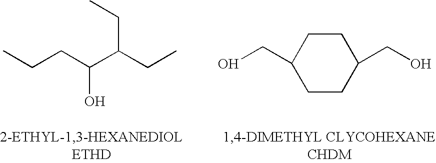

As the formulas show, the carbon in position 2 of the chemically and technically stable esters only contains one hydrogen atom. A rather large group is attached to said carbon in position 2 and said group makes the hydrogen sterically hindered and the compound is not easily hydrolyzed.

According to a first preferred embodiment of the invention, a refrigerant composition is provided, comprising a polyol ester which completely or almost completely (to 95 mol-%, or even to 100%) consists of an ester of CHDM:n and/or ETHD.

According to another preferred embodiment of the present invention, a refrigerant composition is provided, comprising in addition to a complex ester of CHDM and/or ETHD an ester of NPG, TMP, TME, PE, BEPD or TMPD at any ratio.

If the diol or polyol residue of the ester contains a mixture of two different diols, the molar ratio of the first diol to the second polyol, if any, is 5:95 to 99.9:0.1. Preferably in the ester mixtures according to the invention the first diol forms the main part of the polyol residue of the ester, in particular it makes up 50 to 99 mol-%.

ETHD and CHDM or a mixture of these polyols and some other polyol are esterified with a linear or branched C₄ to C₁₈ carboxylic acid or an anhydride thereof. As specific examples of aliphatic, linear or branched, saturated or unsaturated C₄-C₁₈-carboxylic acids which can be used for preparing the ester, the following can be mentioned:

saturated, linear C₄-C₁₈-carboxylic acids: butanoic acid (butyric acid), pentanoic acid (valeric acid), hexanoic acid (caproic acid), heptanoic acid, octanoic acid (caprylic acid), decanoic acid (capric acid), dodecanoic acid (lauric acid) and hexadecanoic acid (palmitic acid) and mixtures thereof;

saturated, branched C₄-C₁₆-carboxylic acids: isobutanoic acid, 2-ethylhexanoic acid, isononanoic acid and 3,5,5-trimethylhexanoic acid;

unsaturated, linear C₄-C₁₈-carboxylic acids: 3-butenoic acid (vinylacetic acid); and

unsaturated, branched C₄-C₁₈-carboxylic acids.

In the mixed esters the ratios between the various linear and branched carboxylic acids can vary within large boundaries. Typically, the linear carboxylic acid(s) is (are) present in amounts of 1 to 100 mol-%, preferably about 10 to 90 mol-% of the amount of carboxylic acids. Correspondingly, the amount of branched carboxylic acids is 99 to 1 mol-%, preferably about 90 to 10 mol-%. In particular it is possible to prepare polyolesters, which contain 10 to 50 mol-% of at least one linear carboxylic acid and 90 to 50 mol-% of a branched carboxylic acid.

Esterifying hydroxy acids are, e.g., hydroxypivalic acid (HPAA), lactic acid, citric acid and dimethylolpropionic acid (DMPA).

In addition to the afore-mentioned, the esterifying carboxylic acid used comprises dibasic carboxylic acids, such as oxalic acid, malonic acid, dimethyl malonic acid, succinic acid, glutaric acid, adipic acid, sebacic acid, pimelic acid, suberic acid and azelaic acid. It is also possible to use cyclic anhydrides, such as succinic anhydride or alkyl derivaties thereof, or trimellitic anhydride. Small amounts of aromatic anhydrides, such as phthalic anhydride are also possible.

The degree of esterification of the polyols is 50 to 100%, preferably as high as possible, at least about 90%. In the esters the ratio between the mono- and dibasic carboxylic acids is 50:50 to 100:0, preferably a maximum of 99:1.

Technically and chemically stable complex esters can be used for preparing refrigerant liquid compositions. These contain as a refrigerant one or several chlorine-free hydrofluoro carbon(s) (a refrigerant) in which the ester is dissolved. As specific examples of the refrigerant liquid component of the compositions, the following can be mentioned: hydrofluorocarbon 134 (1,1,2,2-tetrafluoroethane), hydrofluorocarbon 134a, hydrofluorocarbon 143 (1,1,2-trifluoroethane), hydrofluorocarbon 143a (1,1,1-trifluoroethane), hydrofluorocarbon 152 (1,2-difluoroethane) and hydrofluorocarbon 152a (1,1-difluoroethane). Of these compounds, hydrofluorocarbon 134a is generally preferred. Mixtures of hydrofluorocarbons can also be employed. Examples include hydrofluorocarbon mixture 407 (mixture of hydro-carbons 32, 125 and 134a) and hydrofluorocarbon mixture 410 (mixture of hydrocarbon 32 and 125).

Depending on application, the viscosity requirement for the ester is, according to ISO-standard, between 5 and 200 cSt (40° C.). Low (5-10) and intermediate (22-32) viscosities are needed for, e.g., refrigerators and other smallish refrigeration devices. High viscosity (46-68) compositions are used for, e.g., cooling equipment of air conditioners and extremely high viscosity is needed in large installations.

As already mentioned in the beginning, the viscosity of the prepared esters can be adjusted as desired by suitably selecting esterifying carboxylic acid components and/or adding a further polyol to the ETHD or CHDM. Thus, by using conventional linear or branched carboxylic acids (C₄-C₁₂) and, e.g., adipic acid, it is possible to prepare esters having viscosities in the range of about 5-90 cSt at 40° C. Their viscosity indeces are about 100 and pour points below −40° C. Their solubility in fluorinated refrigerant liquids is usually excellent. By using carboxylic acids together with dibasic acids it is mostly possible to reach lower viscosities than by combining branched hydrocarbons and dibasic acids.

The following examples comprise particularly preferred esters:

Complex esters of ETHD which contain 1 to 40 mol-% dibasic carboxylic acid and 60 to 99 mol % linear and/or branched monobasic carboxylic acid; and complex esters of CHDM which contain 4 to 30 mol-% dibasic carboxylic acid and 96 to 70 mol % linear and/or branched monobasic carboxylic acid.

The complex esters of ETHD and CHDM, as well as complex esters prepared from these diols together with a mixture of another polyol are already as such novel products which can be used for various purposes in lubricant compositions. The esters are the base oils of such compositions and they form the main part thereof, i.e. more than 50 wt.-%, preferably about 80 to 100 wt.-%, of the compositions. Additives are usually employed in amounts of 0 to 20 wt.-% in the compositions for the purpose of modifying the compositions such that they are better suited for various applications. Thus, the esters are suited for use not only in refrigerant liquid compositions but also for all applications mentioned in the beginning.

Conventional additives which can be used in the refrigerant liquid compositions include, e.g., the following: antioxidants, antiwear agents, detergents, defoaming agents and corrosion inhibitors.

Suitable antioxidants include phenols, such as 2,6-di-t-butyl-4-methylphenol and 4,4′-methylene-bis(2,6-di-t-butylphenol); aromatic amines, such as p,p-dioctylphenylamine, monooctyldiphenylamine, phenothiazine, 3,7-dioctylphenothiazine, phenyl-1-naphthylamine, phenyl-2-naphthylamine, alkylphenyl-1-naphthatalamines and alkylphenyl-2-naphthal-amines, as well as sulphur-containing compounds, e.g. dithiophosphates, phosphitest, sulphides and dithio metal salts, such as benzothiazole, tin-dialkyldithiophosphates and zinc diaryldithiophosphates.

Suitable antiwear agents include, for example, phosphates, phosphate esters, phosphites, thiophosphites, e.g. zinc dialkyl dithiophosphates, zinc diaryldithiophosphates, tricresyl phosphates, chlorinated waxes, sulphurised fats and olefins, such as thiodipropionic esters, dialkyl sulphides, dialkyl polysulphides, alkyl-mercaptanes, dibenzothiophenes and 2,2′-dithiobis(benzothiazole); organic lead compounds, fatty acids, molybdenum complexes, such as molybdenum disulphide, halogen substituted organosilicon compounds, organic silicon compounds, borates and halogen-substituted phosphorus compounds.

As specific examples of suitable detergents, the following should be mentioned: sulphonates, aromatic sulphonic acids, which are substituted with alkyl having a long chain, phosphonates, thiophosphonates, phonolates, metal salts of alkylphenols, and alkyl sulphides.

Typical defoaming agents include silicon oils, e.g. dimethylpolysilozane and organic silicon compounds such as diethyl silicates.

Organic acids, amines, phosphates, alcohols, sulphonates and phosphites are examples of corrosion inhibitors.

The esters according to the invention are prepared by a conventional esterification reaction wherein a polyol or a mixture of polyols is (are) reacted with an acid mixture in the presence of a catalyst or without a catalyst. Various acids, such as sulphuric acid, hydro-chloric acid, p-toluene sulphonic acid, butyl titanate, tinoxide etc., are suitable catalysts for carrying out the invention. A particularly advantageous catalyst is tinoxide.

During the reaction, the polyol is reacted with the acid component by using an equivalent amount of acid, a deficient amount of acid or a surplus of acid; the excess acid amounts to typically a maximum of 10 mol-%, preferably about 0.1 to 5 mol-%, in particular about 1 mol-%. The reaction temperature is 150 to 230° C., preferably 170 to 220° C. and in particular about 190 to 210° C.

The esterification can be carried out as a batch or semibatch process for example by adding the remaining acid later on. The most typical embodiment comprises carrying out esterification in the melt phase but it is also possible to use a hydrocarbon-type medium, such as toluene or xylene. The product is neutralized and washed. The degree of esterification of the ester product is preferably over 85%, in particular over 90% and the acid number of the ester is preferably below 0.1 mg KOH/g.

The following examples illustrate the invention. They do not, however, limit the scope of the invention.

In Tables 1 to 3, the following abbreviations are used: kV for kinematic viscosity, VI for viscosity index and PP for pour point.

### EXAMPLE 1

Determination of Ester Solubility

Solubility in fluorinated hydrocarbons was determined as follows: 1 ml of the studied ester was put into a test tube which was closed with a stopper. The test tube was placed in a cold bath at a temperature of −30° C. When the temperature of the test tube and the ester had reached −30° C. (after about 5 minutes), a fluorinated refrigerant, such as R-134a, was added to make a total volume of 10 ml.

The ester-refrigerant mixture was allowed to stand in the bath at −30° C. with possibly a light occasional stirring. After about 15 minutes the mixture was visually assessed and it was determined whether the mixture contained one or two phases. If the ester and the refrigerant liquid formed one phase, the ester is completely dissolved in the refrigerant liquid. If there are two phases present in the mixture, the ester is either partially or completely insoluble in the refrigerant liquid.

### EXAMPLE 2

Preparation of complex esters

The raw materials were weighed in a glass reactor according to the following receipe: ETHD 45.0 g, pentanoic acid 57.5 g and adipic acid 4.3 g. The catalyst used comprised 0.25 g tinoxide. The esterification was carried out by mixing and nitrigating the reaction mixture at about 200° C. The reaction was completed within 7 hours.

The acid excess of the reaction mixture was neutralized with a 10% sodium carbonate solution. Sodium carbonate and tinoxide were removed from the product by filtering. Finally the product was dried on sodium sulphate and filtered.

In a similar manner, other esters were prepared from ETHD, CHDM and isobutanoic acid, pentanoic acid, hexanoic acid, 2-ethylhexanoic acid, lauric acid and adipic acid. The results are summarized in Table 1.

TABLE 1
Complex esters

| | | | | | | | Solu- |
|---|---|---|---|---|---|---|---|
| Sam- | Polyol | Acid | kV_{40° C.} | kV_{100° C.} | | PP | bility in |
| ple | (mol-%) | (mol-%) | (cSt) | (cSt) | VI | (° C.) | R-134a |
| 1 | ETHD | C₅ (95) | 6.6 | 2.0 | — | <−66 | Excellent |
| | (100) | | | | | | |
| 2 | ETHD | Cᵢ₋₄ (86) | 12.7 | 2.9 | 56 | −58 | Excellent |
| | (100) | AA (14) | | | | | |
| 3 | ETHD | Cᵢ₋₄ (82) | 14.9 | 3.3 | 77 | −58 | Excellent |
| | (100) | AA (18) | | | | | |
| 4 | ETHD | Cᵢ₋₄ (67) | 85.8 | 10.7 | 108 | −44 | Excellent |
| | (100) | AA (33) | | | | | |
| 5 | CHDM | 2-EHA | 21.7 | 4.0 | 61 | −54 | Excellent |
| | (100) | (100) | | | | | |

AA = adipic acid
Cᵢ₋₄ = isobutanoic acid
C₅ = pentanoic acid
2-EHA = 2-ethylhexanoic acid

### EXAMPLE 3

Preparation of Polyol/Complex Esters of ETHD

By repeating the process of Example 2 complex esters of mixtures of ETHD and BEPD were prepared. The results are shown in Table 2.

TABLE 2
Polyol/complex esters of ETHD

| | | | | | | | Solu- |
|---|---|---|---|---|---|---|---|
| Sam- | Polyol | Acid | kV_{40° C.} | kV_{100°} C. | | PP | bility in |
| ple | (mol-%) | (mol-%) | (cSt) | (cSt) | VI | (° C.) | R-134a |
| 6 | ETHD | C₅ (95) | 7.1 | 2.1 | 75 | −63 | Excellent |
| | (70) | | | | | | |
| | BEPD | AA (5) | | | | | |
| | (30) | | | | | | |
| 7 | ETHD | C₁₂ (95) | 23.8 | 5.1 | 146 | −37 | Good |
| | (50) | | | | | | |
| | BEPD | AA (5) | | | | | |
| | (50) | | | | | | |
| 8 | ETHD | 2-EHA | 20.3 | 3.8 | 58 | −49 | Good |
| | (50) | (92) | | | | | |
| | BEPD | AA (8) | | | | | |
| | (50) | | | | | | |

AA = adipic acid
C₅ = pentanoic acid
C₁₂ = lauric acid
2-EHA = 2-ethylhexanoic acid

1. A refrigerant composition which comprises a refrigerant comprising a fluorinated hydrocarbon and a polyolester-based lubricant mixed therewith, wherein the polyolester-based lubricant comprises 2-ethyl-1,3-hexanediol esterified with a mixture of mono- and dibasic carboxylic acids, the molar ratio between the mono- and dibasic carboxylic acids in the mixture amounting to 50:50 to 99:1.

2. The refrigerant composition according to claim 1, wherein the diol is chemically and technically stable.

3. The refrigerant composition according to claim 1, wherein the monobasic carboxylic acid residue of the ester is derived from linear or branched C₄-C₁₈-carboxylic acids, or anhydrides or mixtures thereof.

4. The refrigerant composition according to claim 1, wherein the dibasic carboxylic acid residue is derived from oxalic acid, malonic acid, dimethyl malonic acid, succinic acid, glutaric acid, adipic acid, sebacic acid, pimelic acid, suberic acid or azelaic acid, or a cyclic anhydride or an alkyl derivative thereof, or trimellitic anhydride.

5. The refrigerant composition according to claim 1, wherein the fluorinated hydrocarbon based refrigerant is hydrofluorocarbon 134, hydrofluorocarbon 134a, hydrofluorocarbon 143, hydrofluorocarbon 143a, hydrofluorocarbon 152 or hydrofluorocarbon 152a or a mixture of hydrofluorocarbons.

6. A refrigerant base oil comprising a complex ester of 2-ethyl-1,3-hexanediol.

7. The refrigerant composition according to claim 7, wherein the cyclic anhydride is succinic anhydride.
